(19) United States
(12) Patent Application Publication
(10) Pub. No.: US 2002/0066783 A1
(43) Pub. Date: Jun. 6, 2002

(54) Allowance card

(76) Inventor: Kodi Sawin, Austin, TX (US)

Correspondence Address: Robert C. Klinger, Jackson Walker, L.L.P., Suite 600, 2435 North Central Expressway, Richardson, TX, 75080, US

(21) Appl. No.: 09/730,280

(22) Filed: Dec. 5, 2000

Related U.S. Application Data
(60) Provisional application No. 60/202,855, filed on May 8, 2000.
(60) Provisional application No. 60/224,318, filed on Aug. 10, 2000.
(60) Provisional application No. 60/224,466, filed on Aug. 10, 2000.
(60) Provisional application No. 60/224,284, filed on Aug. 10, 2000.

(51) Int. Cl. G06F 17/60

(52) U.S. Cl. 235/379

(57) ABSTRACT

The present invention enables a user to anonymously transact business on the Internet by earning credits, and by accessing independent second-party lines of credit. As a system, the invention includes an allowance card associated with a unique account number, a debit database, and associates the account number with an account stored as data in the debit database. The system also includes at least one credit supplying means. In another embodiment, the invention is a method of accomplishing a transaction with an allowance card. The method includes providing an allowance card linked to a database on the Internet (the allowance card including a means for identification), authenticating said card, and transacting business via credits maintained by an account maintained by said database.

### RELATED APPLICATIONS

The invention is related to and claims priority from the following co-pending U.S. Provisional Patent Applications: serial No. 60/202,855 by Sawin, et al., entitled Technology Integrated Market E.commerce System™ (TIMES™), and filed on May 8, 2000; serial No. 60/224,318, by Sawin, et al., entitled Interactive Environment Tool, and filed Aug. 10, 2000; serial No. 60/224,466 by Herrell, entitled Custom Virtual Character Transfer, and filed on Aug. 10, 2000; and serial No. 60/224,284 by Sawin, et al, entitled Master Selection Environment, and filed Aug. 10, 2000. In addition, the invention is related to the following simultaneously filed co-pending U.S. Patent Applications: Ser. No. TBD, entitled Web Game and Machinima by Sawin, et al., attorney docket number 108368.00004; Ser. No. TBD, entitled Interactive Environment Tool, by Sawin, et al. attorney docket number 108368.00002; Ser. No. TBD, entitled Technology Integrated Market Electronic-Commerce System, by Sawin, et al. attorney docket number 108368.00006; Ser. No. TBD, entitled Custom Virtual Character (CVC), and Systems and Methods for CVC Transfer, by Sawin, et al., attorney docket number 108368.00003. All of the aforementioned patent applications are hereby incorporated by reference.

### TECHNICAL FIELD OF THE INVENTION

The invention generally relates to computer games, role-playing games, and the Internet, and, more particularly, the invention relates to systems, devices, and methods for customizing characters used in computerized gaming environments, and systems, devices, and methods for manifesting the customized characters in environments beyond the computer gaming environment.

### STATEMENT OF A PROBLEM ADDRESSED BY THE INVENTION

The financial part of most Internet-based purchases are completed by using a credit card to pay for the purchase. Unfortunately, consumers perceive problems with using credit cards to make purchases over the internet. Some of these problems include privacy issues, and use issues. Privacy issues arise because the owner of a credit card may be readily identified as the purchaser of an item or service, particularly when that purchase is made over the internet. Use issues include inefficiencies in credit card processing.

For example, one use issue arises because it is inefficient for companies to process small payments-the cost of a transaction, including administrative overhead, may exceed the profit on a small transaction. Another use issue is access. For example, some individuals (such as children) do not have access to credit cards. Accordingly, a purchasing solution is needed that overcomes the privacy and use issues associated with credit card transactions.

One solution allows a linking of credit from a primary credit card to a secondary credit card (such as a parent in a parent/child relationship). Unfortunately, since the two cards are linked together, there is no form on anonymity for the primary credit card account. Thus, should someone gain access to the secondary card, there is the possibility of someone gaining access to the parental card by using the child's account information. Furthermore, there is no secondary card independent of the primary card. Other attempted solutions suffer from similar disadvantage. Therefore, there exists the need for a credit/debit card system that provides the advantages of anonymous transactions and that minimizes use issues.

### SELECTED OVERVIEW OF SELECTED EMBODIMENTS

The present invention achieves technical advantages as a system, method and software for enabling an user who is independent from a primary card holder to receive marketable credits. For example, such a system would enable a parent to regulate the spending of a child. Such a system would realize additional advantages if a user could independently earn credits. It would be additionally advantageous to provide merchants and manufacturers with a means to track products sold to a card holder, and to then reward the card holder with credits, while providing anonymity to primary card holders, and to cardholders who whish to remain anonymous. Accordingly, merchants gain valuable information about consumer preferences. For example, a toy or video game company could discover the types of toys and gaming instruments consumers most enjoy.

In one embodiment, the invention is an allowance card having a stored value representing credits. The allowance card may be sold through retail outlets, kiosks, or over the Internet, for example. The initial denominations of the card may vary, and the card may accept payment in different currency types. In addition, the allowance card may maintain a unique identification number which may be associated with a database number maintained in a main database account. The database number may be maintained on an Internet site. Accordingly, one method of activating the allowance card is to associate an allowance card number (which may also be associated with a personal identification number), with the database number upon the first or subsequent use of the card. Accordingly, the user may purchase items until the card is exhausted of credits.

An allowance card may be gain credits by crediting the allowance card with any credit card, or any other account having an electronic transfer means. Furthermore, if a user chooses to make anonymous purchases (not link the allowance card to any traceable line of credit) a user may still gain points as part of an anonymous reward system. Furthermore, the user may elect to use an allowance card that is both anonymous and linked to a creditable account.

Another aspect of the invention provides merchants and manufacturers with a system to reward customers for purchasing particular products. Accordingly, products, such as a particular toy or brand of cereal, may provide a certain number of credit points that may provide credits to an allowance card.

In another embodiment, the invention enables a user to combine multiple purchasable allowance cards via a main website on the Internet. In one specific embodiment, such a system allows for multiple adults to purchase credits for a single allowance card, thus enabling a child holder of the allowance card to make purchases. Parents and children may elect to be notified by e-mail or other electronic means when the credits are expended below some predetermined threshold. The information regarding the allowance card, and its corresponding credit balance, will preferably be stored on a dedicated main server.

The invention, in yet another embodiment, provides a database driven, proof-of-purchase clearing house. Accordingly, the allowance card may function as a reward card, recognizing the SKU or UPC symbol from a proof-of-purchase, and thereby automatically reward the allowance card holder with credits related to the proofs-of-purchase.

### BRIEF DESCRIPTION OF THE DRAWINGS

Various aspects of the invention, as well as at least one embodiment of the invention, are better understood by reference to the following EXEMPLARY EMBODIMENT OF A BEST MODE. To better understand the invention, the EXEMPLARY EMBODIMENT OF A BEST MODE should be read in conjunction with the drawings, in which:

FIG. 1 is shows one embodiment of the allowance card system and environment; and

FIG. 2 is a flow diagram of a method of using of the invention.

### AN EXEMPLARY EMBODIMENT OF A BEST MODE

The invention enables a primary card holder to provide credits to a holder of a second, secondary card (hereinafter, “allowance card”). For example, a parent may provide for and monitor the spending of a child. Such an invention provides additional advantages when a user is enabled to independently earn credits. The invention also provide merchants the ability to track products sold to a card holder, and to then reward the card holder with credits while providing anonymity to at least the primary card holder. Thus, the present invention provides systems, methods, and software for enabling an allowance card user to earn or receive marketable credits.

When reading this section (An Exemplary Embodiment of a Best Mode, which describes an exemplary embodiment of the best mode of the invention, hereinafter “Detailed Description”), one should keep in mind several points. First, the following Detailed Description is what the inventor believes to be the best mode for practicing the invention at the time this patent was filed. Thus, since one of ordinary skill in the art may recognize from the following Detailed Description that substantially equivalent structures or substantially equivalent acts may be used to achieve the same results in exactly the same way, or to achieve the same results in a not dissimilar way, the following Detailed Description should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary at) that a substantially equivalent structure or substantially equivalent at may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an at should be interpreted as incorporating all modes of doing that function or at, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”). Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for —functioning”— or “step for —functioning” in the claims section.

Computer Systems as an Exemplary Device

A computer system (or, “system”) typically includes hardware capable of executing machine readable instructions, as well as the software for directing acts (typically machine-readable instructions) that produce a desired result. In addition, a computer system may include hybrids of hardware and software, as well as computer sub-systems.

Hardware also generally includes processor-capable platforms, such as client-machines (also known as personal computers or servers), and hand-held processing devices (also called personal computing devices (PCDs)), such as smart phones, personal digital assistants (PDAs), or palm devices, for example. Furthermore, hardware typically includes any physical device that is capable of storing machine readable instructions, such as memory or other data storage devices. Other forms of hardware include hardware sub-systems, including transfer devices such as modems, modem cards, ports, and port cards, for example. The way hardware is organized within a system is known as the system's architecture (discussed below).

Software includes machine readable instructions stored in RAM or ROM, machine code stored on other devices (such as a floppy disk, or a CD ROM, for example), and may include machine executable instructions, an operating system, as well as source or object code, for example.

Programs often execute in portions of code at a time. These portions of code are sometimes called modules or code-segments. Often, but not always, these code segments are identified by a particular function that they perform. For example, a counting module (or “counting code segment”) may monitor the value of a variable. Furthermore, the execution of a code segment or module is sometimes accomplished as one or more acts. Accordingly, software may be used to perform a method which comprises acts. In the present discussion, sometimes acts are referred to as steps to help the reader understand a specific embodiment of the invention.

Hybrids (combinations of software and hardware) are becoming more common. One hybrid is created when what are traditionally software functions are directly manufactured into a silicon chip-this is possible since software may be assembled and compiled into ones and zeros, and, similarly, ones and zeros can be represented directly in silicon. Typically, hybrid functions are designed to operate seamlessly with software. Accordingly, it should be understood that hybrids and other combinations of hardware and software are also included within the definition of a computer system, and are thus envisioned by the invention as possible equivalent structures and equivalent methods.

Computer sub-systems are combinations of hardware or software or hybrids that perform some specific task. For example, one computer sub-system is a soundcard. A soundcard provides hardware, hardware connections, memory, and software for enabling sounds to be produced and recorded by a computer system. The soundcard's software may include software needed to enable a computer system to “see” the soundcard, recognize the soundcard, and drive the soundcard.

Sometimes the methods of the invention may be practiced by placing the invention on a computer-readable medium. Computer-readable mediums include passive data storage, such as a random access memory (RAM) as well as semi-permanent data storage such as a Compact Disk Read Only Memory (CD-ROM), or a compact flash card, for example. In addition, when the invention may be embodied in the RAM of a computer, it may transform a computer or computer system into a new specific computing machine (or devise) or new specific computing system.

Data structures are organizations of data, and enable an embodiment of the invention. For example, a data structure may provide an organization of data, or an organization of executable code (executable software). Accordingly, a table of equations or data values may comprise one aspect of the invention. Furthermore, data signals are carried across transmission mediums, such as coaxial cable, twisted pair wire, or fiber-optic cable, for example. Accordingly, a transmission medium may transport (and even store) various data structures, and, thus, may be used to move the invention from one location to another. Furthermore, the embodiment of invention as software in the transmission medium creates a unique, device embodiment of the invention. It should be noted in the following discussion that acts with like names are performed in like manners, unless otherwise stated.

Exemplary Architectures

The invention should not be interpreted as being limited to any specific architecture. However, a better understanding of the invention can be achieved by examining an exemplary architecture on which the invention can be implemented. Since, for example, software running on a single computer is well known in the art, a discussion of the invention executing on a single computer, and other architectures well known in the art, will not be discussed here.

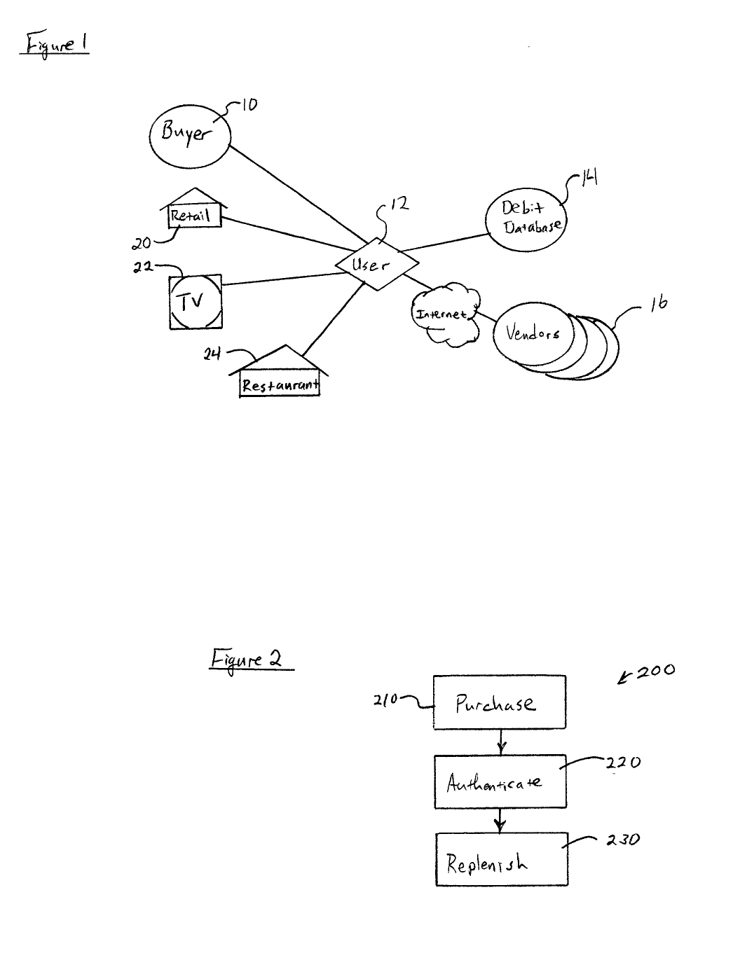

FIG. 1 illustrates one embodiment of an allowance card system 100. The allowance card system 100 contemplates a buyer 10 of an allowance card. The buyer could be any person or business entity. The allowance card that is purchased may have a predefined credit value, and may be sold through any retail outlet, kiosk, or over the Internet, for example.

Allowance cards may incorporate marketing features, such as brand identification marks (such as a company logo), and may be configured for limited use, such that a company card can be used only with respect to that company's sales outlets. Preferably, each allowance card is associated with a unique database number. The database number may be stored on the allowance card as a number or bar-code hidden by a scratch-off compound, or may be stored on a magnetic strip.

Once an allowance card is obtained, the user 12 is then able to access designated Internet sites for spending or using credits. One Internet site may maintain a debit database 14. Accordingly, the user 12 may access the debit database 14 and enter the database number. The database number is unique, and correlates to an allowance card account stored in the database. Initially, the number of credits allocated to the account may correspond to a credit value that may be illustrated on the allowance card (or it's packaging). The user 12 may then purchase goods or services from a vendor 16, by debiting the account number associated with the allowance card until the credits allocated to that allowance card are exhausted. Accordingly, as the user 12 purchases goods and services from vendors 16, the account in the debit database 14 associated with the user's 12 particular debit card is lowered.

For example, a credit may be purchased for a quarter-dollar. A buyer may purchase $100 of credits, for a total of 400 credits. These credits are already associated with a database account, but may be re-assigned to an existing database account. Of course, the user may be the same as the buyer, or a different person from the buyer. Thus, the user may claim anonymity.

Accordingly, if the user purchases an item costing $10 with the allowance card, 40 credits are debited (taken away from) the card (leaving 360 credits). Upon the crediting (increasing the value) of the database account (which is preferably stored in the debit database 14), it may be desirable to invite the user 12 or the buyer 10 to provide a means of communicating with them, such as an email address. Accordingly, the providers of the debit database 14 obtain the ability to alert a user 12 or a buyer 10 when the number of credits in the account become limited, or drop below a predetermined number.

Any person or business may replenish a known database account. For example, an additional allowance card may be purchased, and its credits may be applied to the database account that was already created for the user. Thus, if one person purchases a ten thousand credit denomination card, and another person purchases a twenty thousand credit denomination card, the user 12 may receive and combine the credits from the two cards to make purchases of good or services from a single database account.

Another method a person may use to augment the database account is a credit card debit. Persons may elect to use a credit card or other credit line to provide additional credits to the allowance card by accessing the database account over the internet. For example, a user may purchase a particular number of credits at one time, such as buying thirty credits.

A user may also designate a credit line to tap to maintain a minimum credit level. For example, a user 12 may elect to add 1000 credits to the account when the number of credits in the account falls below 100 credits. In addition, a user 12 may have credits periodically assigned to the account. For example, the user 12 may have 10,000 credits placed on the account on the first of each month, or on some other periodic basis (weekly, bi-weekly, etc.). Accordingly, such an account functions as an allowance of credits, which could be ideal for a student user. Thus, a user 12 has a great deal of flexibility in choosing the means to which they elect to replenish a database account.

Non-Purchase Methods of Obtaining Credits

A user 12 may procure additional credits by accessing selected goods and services, such as Internet services. One embodiment of the invention provides a database driven proof-of-purchase clearing house. Accordingly, the allowance card functions as a “reward card,” recognizing a product SKU, such as a proof-of-purchase of a product, and then automatically reward the database account with points to reflect the purchase. The code numbers thereby act as a proof-of-purchase system by which the user will be able to earn database account credits.

One proof-of-purchase clearing house is associated with a retail outlet 20. Accordingly, user 12 may purchase goods such as food candy, toys, or clothes, for example, from the retail outlet 20. The goods that carry pre-approved proof-of-purchase numbers have various credit denominations associated with each proof-of-purchase. Then, the user 12 provides the SKU to a webpage so that the debit database 14 may convert the SKU into credits. For example, many users 12 are familiar with the toy prizes contained in breakfast cereal boxes. Then, instead of a toy prize, the gimmick may entail a clue game, or some picture, or other puzzle to be deciphered. Then, the user 12 may decipher the game or puzzle before the user 12 can translate the value of the card into credits. At other times, a user 12 may find a prize card maintaining specific credits within a cereal box. Toys, games, or other “hard goods” with registered number coupons, proof-of-purchase numbers, UPC symbols, or scratch off numbers facilitate this type of system.

As another example, a user 12 may find similar prizes at a fast food restaurant 24 (or other restaurants catering to children and young adults). These restaurants may provide prizes associated with credits for an allowance card in “kids meals”. These prizes could be in the form of coupons, scratch off cards, or proof of purchase symbols.

Television programs (TV) 22 also may play a role in providing a user 12 credits. For example, television programs may provide code numbers at points during the program, or during program advertising. A user 12 watching these programs may input these codes into their allowance card's debit database 14 to earn credits.

Physically, it is important to note that the actual allowance card may be a variety of shapes, sizes and media. Preferably, the card is a physical plastic card maintaining a computer generated code, such as a bar code or numeric code, or a magnetic strip. The magnetic strip is in one embodiment dataless prior to purchase of the card. In other words, the allowance card is not associated with a database. The strip is thus capable of activation at the point of purchase by either the retail salesperson or via the Internet, for example. The card may, however, maintain a scratch off substance or peel off substance concealing a barcode or other authorization number.

A better understanding of the invention may be obtained from examining a flow-diagram that describes one embodiment of the invention. Accordingly, FIG. 2 is a flow diagram of an allowance card algorithm 200. Initially, a buyer purchases a card 20 in a purchase act 210. The purchase may be made at any number of retail venues or on the Internet, for example. The card may be maintained in a resilient and magnetic field resistant envelope.

Next, the user authenticates the card in an authentication act 220. Authentication may by accomplished by accessing a web site having access to a database account, and entering information to associate the credits of the card with the database account. Preferably, the authentication act 220 obtains selected information about the user (such as an address for shipping purposes, an e-mail address, or other form of electronic communication).

Once a database account is created, the user may add credits to the database account via any of previously disclosed methods in a replenishment act 230. Accordingly, television 22, retail 20, fast food 24 and buyers 20 are merely just a few examples of how a user 12 may obtain additional credits for their database account. Additional means of earning account credits include, but are not limited to, game playing, winning a particular level of game, visiting a website, for example.

Although preferred embodiments of the method and system of the present preferred embodiments has been illustrated in the accompanied drawings and described in the foregoing detailed description, it is understood that obvious variations, numerous rearrangements, modifications and substitutions can be made without departing from the spirit and the scope of the invention as defined by the appended claims.

What is claimed is:

1. A system for providing business transactions over the Internet, said system comprising:
an allowance card associated with a unique account number;
a debit database;
the account number associated with an account stored as data in the debit database; and
at least one credit supplying means.

2. The system of claim 1 wherein said account is maintained is anonymously.

3. The system of claim 2 wherein said account is credited by obtaining credits associated with product or service purchases.

4. The system of claim 1, wherein the account is replenished by credit an account with credits obtained via the purchase of additional allowance cards.

5. The system of claim 1, wherein said credit supplying means is a creditable account accessible via the Internet.

6. The system of claim 1, further comprising purchasing credits on a periodic basis.

7. The system of claim 6, wherein said purchasing is enabled by the debit database being linked to a credit card account.

8. The system of claim 1, wherein the allowance card has a magnetic strip disposed thereon.

9. The system of claim 8, wherein said magnetic strip is dataless prior to an activation.

10. The system of claim 1, wherein the allowance card is identifiable by a bar code, the barcode being associated with an account.

11. The system of claim 10, further comprising a means of concealing the bar code.

12. The system of claim 1, further comprising an electronic alert system for alerting the user to low or dwindled credits.

13. The system of claim 12 wherein said electronic alert system operates via electronic mail.

14. A method of accomplishing a transaction with an allowance card, said method comprising:
providing an allowance card linked to a database on the Internet, said allowance card comprising a means for identification;
authenticating said card; and
transacting business via credits maintained by an account maintained by said database.

15. The method of making a transaction of claim 14, further comprising adding credits to the allowance card.

16. A packaged debit card, comprising:
a replenishable debit card having a computer generated code, said computer generated code being covered by a concealing means for removal and exposure of said code after purchase;
a specific company logo branded upon said card signifying which site's accept such a card;
a magnetic strip maintained on the debit card, said strip being inactive but capable of activation at the point of purchase; and
a mounting envelope for mounting said debit card while said magnetic strip is exposed, said envelope sandwiching said debit card.

17. The packaged debit card assembly of claim 16, wherein said computer generated code is a bar code.

18. The packaged debit card assembly of claim 16, wherein said computer generated code is a numeric code.
